(19) United States
(12) Patent Application Publication
(10) Pub. No.: US 2023/0150322 A1
(43) Pub. Date: May 18, 2023

(54) TRAILER JACK SUPPORT SYSTEM, SUPPORT BLOCK ASSEMBLY AND SUPPORT BLOCK THEREFOR

(71) Applicant: DOCK N STOW LLC, HIGHLANDS RANCH, CO (US)

(72) Inventor: Mark Gregory, Highlands Ranch, CO (US)

(21) Appl. No.: 17/984,533

(22) Filed: Nov. 10, 2022

Related U.S. Application Data
(60) Provisional application No. 63/278,843, filed on Nov. 12, 2021.

(51) Int. Cl. B60D 1/66; B60R 9/00

(52) U.S. Cl. CPC B60D 1/66; B60R 9/00

(57) ABSTRACT

A support block can support a jack post on a trailer and is stored on a docking mechanism near the tongue or hitch of the trailer for easy deployment when needed and quick, secure storage when not needed. The stored support block can be removed for use with via several options. The support block is then free to be removed from its storage position and can be used to support and/or level the trailer and prevent the jack post from sinking into the ground. To replace the support block, the user locates the support block on the docking mechanism or trailer frame and secures it in place. Initial assembly of the device can require tools to couple a mounting plate to the trailer, onto which the block is stored. Thereafter, attachment and removal of the support block to the mounting plate does not require tools.

### CROSS-REFERENCE TO RELATED APPLICATION

The application claims priority to and the benefit of U.S. Prov. Pat. App. No. 63/278,843, filed Nov. 12, 2021, which is incorporated herein by reference in its entirety.

### BACKGROUND

### 1. Field of the Invention

The present disclosure relates generally to trailers towed by motor vehicles. More particularly, the present disclosure is directed to support members for supporting a jack post of the trailer while in a stationary, detached state from the motor vehicle.

### 2. Related Art

Towable trailers typically have a support stanchion, also referred to as support post, jack post or jack stand, near a front of the trailer, which is generally referred to as the tongue of a frame of the trailer. The jack post is extendable to a ground surface for support and/or leveling of the trailer while the trailer is unhitched in a detached or uncoupled state from the motor vehicle. The jack post, if not supported by an intermediate support member, can sink into the ground surface under the weight of the trailer, causing the trailer to become not level. In some cases, the trailer becomes unstable and the jack post damages the ground surface. This can make it difficult to remove the support post from the ground, particularly under the weight of the trailer. Additionally, raising and lowering the jack post (which is done manually) over the entire distance between a bottom of the jack post and the ground surface can be laborious and time consuming. To remedy this, some trailer users place a cement cinder block or a piece of wood under the support post to prevent it from sinking into the ground surface and to save effort and time in the lowering and raising of the jack post. Although these techniques can be useful, they are generally heavy and cumbersome to stow for future use. For example, the cinder block or wood can be stowed in an interior compartment of the trailer (e.g., in a trailer home), or in a trunk or passenger compartment of the motor vehicle, which can take up valuable storage space. Moreover, the cinder block or wood can degrade with extended use over time, and will need to be replaced. Thus, improvements in trailer jack support systems continue to be of interest.

### SUMMARY

When not in use supporting a jack post of a trailer, a support block constructed in accordance with this disclosure is designed to be securely stored on the trailer, such as in a convenient, readily accessible location, including, by way of example and without limitation, near the tongue of the trailer. The support block can be operably coupled to a frame of the trailer. The frame can be made of any material in any of the standard tubing geometries common to trailer frame applications such as, but not limited to, rectangular, square, I-beam and C-channel. The support block can be operably attached to any width of trailer frame material, with common widths ranging from 1.5 inches to 4 inches, though the support block can be attached to larger or smaller trailer frame widths. A coupling mechanism allows for easy and rapid deployment of the support block when needed for use, and quick, secure storage when the support block is not in use.

A support block assembly constructed in accordance with the disclosure can be used by individuals or businesses that engage in the activity of towing trailers of all types including, but not limited to, trailer-mounted recreational shelters, small mobile homes or offices, utility trailers, boat or recreational equipment trailers, industrial or construction equipment trailers, vehicle trailers, material-hauling trailers, or more generically, cargo trailers. Such applications need to securely and conveniently store a support block when not in use and rapidly and effectively deploy the support block when needed.

With the support block being securely and conveniently stored near the tongue of a trailer frame, in a specifically selected, openly viewable, accessible and deployable configuration, users are unlikely to lose the support block or neglect to use it. Furthermore, the ease and speed with which the support block is constructed in accordance with this disclosure can be detached and deployed, and then returned to its storage location on the trailer frame after use is very efficient.

In accordance with the above objects, features and advantages, a support block assembly for attachment to a trailer frame is provided. The support block assembly includes a support block and an intermediate coupler member configured for attachment to the trailer frame, wherein the support block is configured for attachment to the intermediate coupler member.

In accordance with another aspect of the disclosure, the intermediate coupler member can be configured for direct attachment to the trailer frame and the support block can be configured for direct attachment to the intermediate coupler member.

In accordance with another aspect of the disclosure, a support block assembly configured to be coupled to a trailer frame of a trailer in accordance with an aspect of the disclosure includes a support block having a first side configured to engage a ground surface and a second side, opposite the first side, configured to engage a jack post of the trailer, and an intermediate coupler member. The intermediate coupler member is configured for releasable attachment to the trailer frame and to the support block, such that the support block can be readily detached from the intermediate member for use in supporting the jack post by placing the first side of the support block along the ground surface and the second side of the support block into engagement with the jack post. Then, when done supporting the jack post, the support block can be readily reattached to the intermediate coupler member for stowage.

In accordance with another aspect of the disclosure, the intermediate coupler member can be configured to remain attached to the trailer frame while removing the support block from the intermediate coupler member for use in supporting the jack post.

In accordance with another aspect of the disclosure, the intermediate coupler member can be configured for quick attachment to the trailer frame via a first connection mechanism and for quick attachment to the support block via a second connection mechanism, wherein at least the second connection mechanism can be configured for coupling and decoupling with the support block without use of secondary tools.

In accordance with another aspect of the disclosure, the first and second connection mechanisms can be configured for coupling and decoupling with the trailer frame and the support block, respectively, without use of secondary tools.

In accordance with another aspect of the disclosure, the first connection mechanism can be adjustable to accommodate different configurations of trailer frames.

In accordance with another aspect of the disclosure, a method of stowing a support block on a trailer frame is provided. The method includes attaching an intermediate coupler mechanism to the trailer frame, and then, coupling the support block to the intermediate coupler member.

In accordance with another aspect of the disclosure, the method includes attaching an intermediate coupler mechanism directly to the trailer frame, and then, coupling the support block directly to the intermediate coupler member.

In accordance with another aspect of the disclosure, the method includes coupling the support block directly to the intermediate coupler member without using secondary tools.

### BRIEF DESCRIPTION OF THE DRAWINGS

These and other objects, features and advantages of the present disclosure will be readily appreciated, as the same becomes better understood by reference to the following detailed description when considered in connection with the accompanying drawings wherein:

FIG. 1 is a schematic elevational view showing a motor vehicle arranged to tow a trailer along a ground surface with a support block assembly constructed in accordance with the disclosure shown releasably attached to a trailer frame of the trailer;

FIG. 2 is a view similar to FIG. 1 showing the trailer detached from the motor vehicle with a jack post lowered onto a support block of the support block assembly to support the trailer in a stationary location on the ground surface;

FIGS. 3A and 3B, respectively, illustrate top and side views of an intermediate coupler member of the support block assembly constructed in accordance with one aspect of the disclosure, with the intermediate coupler member shown mounted to the trailer frame in accordance with another aspect of the disclosure;

FIG. 4 is a side view of the intermediate coupler member of the support block assembly constructed in accordance with one aspect of the disclosure, with the intermediate coupler member shown mounted to a trailer frame in accordance with another aspect of the disclosure;

FIGS. 5A and 5B illustrate top and side views, respectively, of a block coupled to an intermediate coupler member of a support block assembly constructed in accordance with another aspect of the disclosure;

FIGS. 6A-6C illustrate top, side and end views, respectively, of a block coupled to an intermediate coupler member of a support block assembly constructed in accordance with another aspect of the disclosure;

FIGS. 7A-7C illustrate top, side and end views, respectively, of a block coupled to an intermediate coupler member of a support block assembly constructed in accordance with another aspect of the disclosure;

FIGS. 8A and 8B illustrate top and bottom views, respectively, of an intermediate coupler member of a support block assembly constructed in accordance with another aspect of the disclosure, with the intermediate coupler member shown mounted to a trailer frame in accordance with another aspect of the disclosure;

FIGS. 9A and 9B show top and end views, respectively, of a block coupled to an intermediate coupler member of a support block assembly constructed in accordance with another aspect of the disclosure; and

FIGS. 10A and 10B show top and end views, respectively, of a block coupled to an intermediate coupler member of a support block assembly constructed in accordance with another aspect of the disclosure.

### DETAILED DESCRIPTION

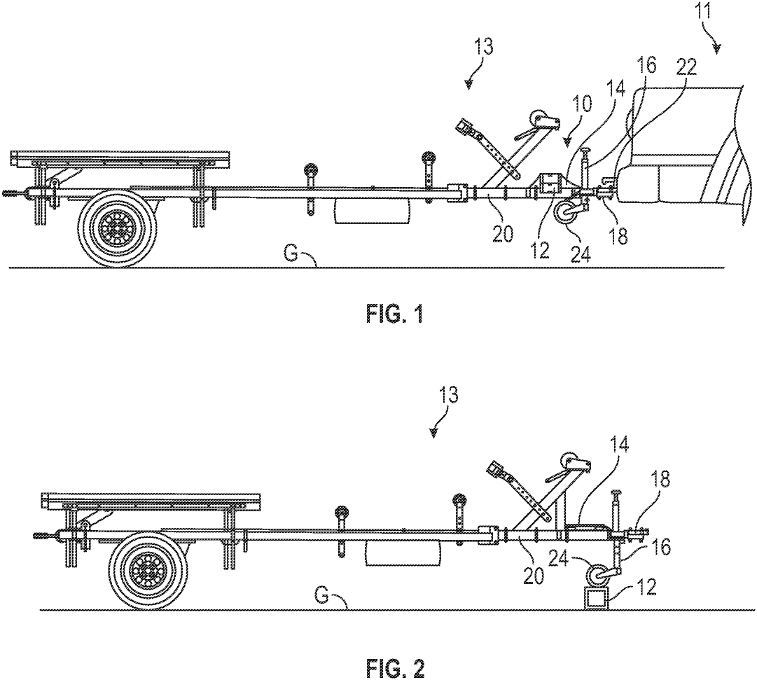

FIGS. 1-10 disclose embodiments of a trailerjack support system. For example, in FIG. 1, a motor vehicle 11 is shown having a trailer 13 attached thereto such that the motor vehicle 11 can tow the trailer 13 along a ground surface G in normal fashion. In FIG. 2, the trailer 13 is shown detached from the motor vehicle 11, such is common practice while using or while storing the trailer 13, depending on the type of trailer, e.g. trailer-mounted recreational shelters, small mobile homes or offices, utility trailers, boat or recreational equipment trailers, industrial or construction equipment trailers, vehicle trailers, material-hauling trailers, or more generically, cargo trailers. To facilitate supporting the trailer 13 when detached from the motor vehicle 11, a support block assembly 10 is provided in accordance with the disclosure, with the support block assembly 10 having a support block 12 and a mounting member, also referred to as mounting plate, intermediate member or intermediate coupler member 14. The intermediate coupler member 14 is configured for releasable attachment to the trailer 13 as well for quick connection to the support block 12. Then, when desired, the support block 12 can be quickly and easily detached from the intermediate coupler member 14 for use in combination with a trailer jack, referred to hereafter as jack post 16, of the trailer 13, to secure the trailer 13 in a stationary, level orientation on the ground surface G. Of course, when desired to tow the trailer 13, the tongue 18 can be readily coupled to a hitch 22 of the motor vehicle 11, the jack post 16 can be returned to its stowed, retracted state, and the support block 12 can be stowed via being easily and quickly reattached to the intermediate coupler member 14 without the need of secondary tools.

The jack post 16, as discussed above, is used to support the front end, commonly referred to as the tongue 18, of a trailer 13. The tongue 18 is configured for releasable coupling to a rear end of the motor vehicle 11, as is known. When in use, typically while the tongue 18 of the trailer 13 is detached from the towing motor vehicle 11, but never while the motor vehicle 11 is towing the trailer 13, the jack post 16 can be extended vertically from a trailer frame 20 of the trailer 13 to the ground surface G to support a tongue weight of the trailer 13. The jack post 16 is typically adjustable in height to facilitate leveling the trailer 13. When the jack post 16 is not in use, it typically folds up against and/or alongside the trailer frame 20 so as not to contact the ground when the trailer 13 is in being towed, though some jack posts 16 can retract exclusive in a vertical direction such that they do not fold laterally.

An end of the jack post 16 that is intended to contact the ground surface G may have a small wheel 24 or pad coupled thereto or the end may simply terminate at a free end. Use of the support block 12 disclosed herein prevents the problem discussed above encountered during use, namely, the jack post, pad or wheel sinking into the ground surface G due to the weight of the trailer 13 especially if the ground surface G is soft dirt, mud, sand, or even asphalt.

The support block assembly 10 constructed in accordance with the disclosure herein solves at least those problems discussed above by allowing the user to quickly and easily store the jack support, referred to above as a “support block 12”, on the trailer frame 20, such as within close proximity to the tongue 18, if desired, or on any other region of the trailer frame 20 desired, regardless of the dimensions and material of the trailer frame 20. Accordingly, the support block assembly 10 and intermediate coupler member 14 thereof can be configured to accommodate any size and/or shape of trailer frame 20 or tongue 18, thereby being universally useful with many different types and styles of trailers 13.

The intermediate coupler member 14 can include a portion of the jack post 16 that is coupled either directly to the trailer frame 20, or as a standalone member which is itself connected directly to the trailer frame 20. Embodiments of the disclosure include apparatus and methods to 1) couple the support block 12 directly to the trailer frame 20, 2) couple the intermediate coupler member 14 directly to the trailer frame 20, and 3) couple the support block 12 to the intermediate coupler member 14, wherein the intermediate coupler member 14 is coupled to the trailer frame, either directly or indirectly. The various aspects, embodiments, implementations and/or features of the embodiments disclosed herein can be used separately or in any combination with one another, where possible.

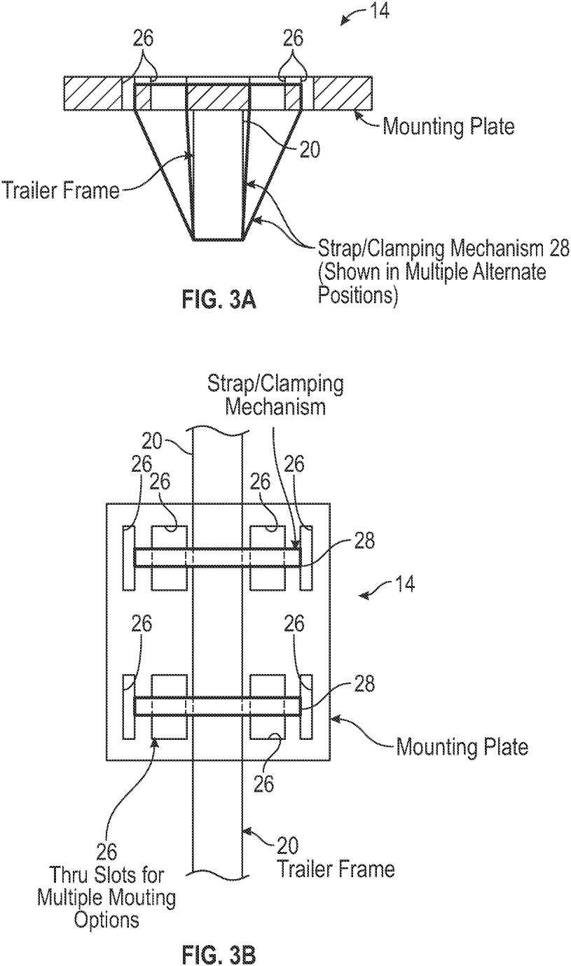

In FIGS. 3A and 3B, the intermediate mounting plate, referred to as intermediate coupler member 14, is shown having through-slots 26 that allow for a coupling mechanism 28, including clamping and/or cinching mechanisms, such as a flexible strap 28, by way of example and without limitation, to be adjusted to trailer frame beams 20 of various sizes and geometric profile shapes. The strap 28 can be a metal, plastic, rubber, textile (woven, braided, knit) (fabricated of any suitable high strength yarns, whether monofilaments and/or multifilaments, including from polymeric and/or natural fibers), with a clasp, buckle, metal or plastic cam, hook, hook and latch, hook and loop (Velcro), bolt or peg with grommet, used in a single or a plurality of configurations to couple the strap 28 to itself, the mounting plate 14, or to the trailer frame 20 while holding the mounting plate 14 securely in place. The strap 28 can be tightened in place with inelasticity, elasticity, friction, clamp, screw mechanism, turn-buckle, ratchet, cam or lever used in a single or a plurality of configurations, by way of example and without limitation. The coupling mechanism 28 can be a clamp that secures the mounting plate 14 to the trailer frame 20 with rigid or flexible features that extend outwardly, such as vertically or horizontally, from the mounting plate 14 and are secured by means of a screw, cam, suction cup, friction, magnet, clasp, hook and latch, bar clamp, or adhesive material used in a single or a plurality of configurations. The coupling mechanism 28 can be a combination of a strap and clamp as described above used in a single or a plurality of configurations. These mechanisms can be used to mount the support block 12 to the trailer frame 20 directly without the use of a separate mounting plate 14, if desired, though the mounting plate 14, as discussed above, can be precisely tailored to facilitate quick and easy attachment/detachment.

In the coupling mechanism 28 to trailer frame 20 embodiment, a clamp with variable tensioning mechanisms can securely couple the mounting plate 14 to a trailer frame 20 made from almost any rigid material of almost any cross-sectional geometry. Through-slots 26 in the mounting plate 14 allow the coupling mechanism 28 to be adjusted for trailer frame beams of various sizes textile materials, as discussed above, and having any variety of geometric profile shapes. The coupling mechanism 28 can be made of metal, plastic, rubber or natural fiber that extend outwardly, including vertically or horizontally, from the mounting plate 14 and are secured by means of a screw, cam, suction cup, friction, magnet, clasp, hook and latch, bar clamp, or adhesive material, by way of example and without limitation, used in a single or a plurality of configurations.

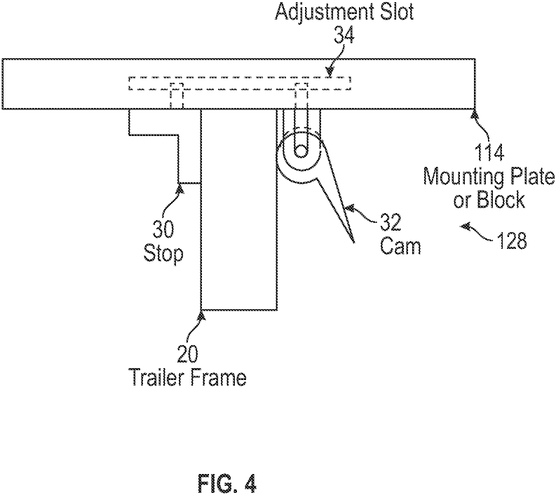

In FIG. 4, an intermediate coupler member 114 in accordance with another aspect of the disclosure is shown having a coupling mechanism 128 in the form of a clamp mechanism used to couple the mounting plate 114 or block (not shown) directly to the trailer frame 20. The clamp mechanism 128 can be orientated horizontally or vertically and secured in place with an adjustable stop 30 and a clamping mechanism, also referred to as clamp member 32, such as a cam, ratchet, screw, nut, bolt, lever, rotating lobe, friction device or adhesive material used in a single or a plurality of configurations. At least one of the adjustable stop 30 and clamp member 32, and shown as both, by way of example and without limitation, are adjustable for movement along a slot 34, whereupon being located in the desire position, the respective adjustable stop 30 and clamp member 32 can be fixed against movement relative to the slot 34.

In the horizontal frame clamp embodiment, the adjustable stop 30 and clamping mechanism 32 are used to secure the mounting plate 114 to the trailer frame 20. The clamping mechanism 32 can incorporate a cam, ratchet, screw, nut, bolt, lever, rotating lobe, friction device or adhesive material to secure the mounting plate to the trailer frame 20.

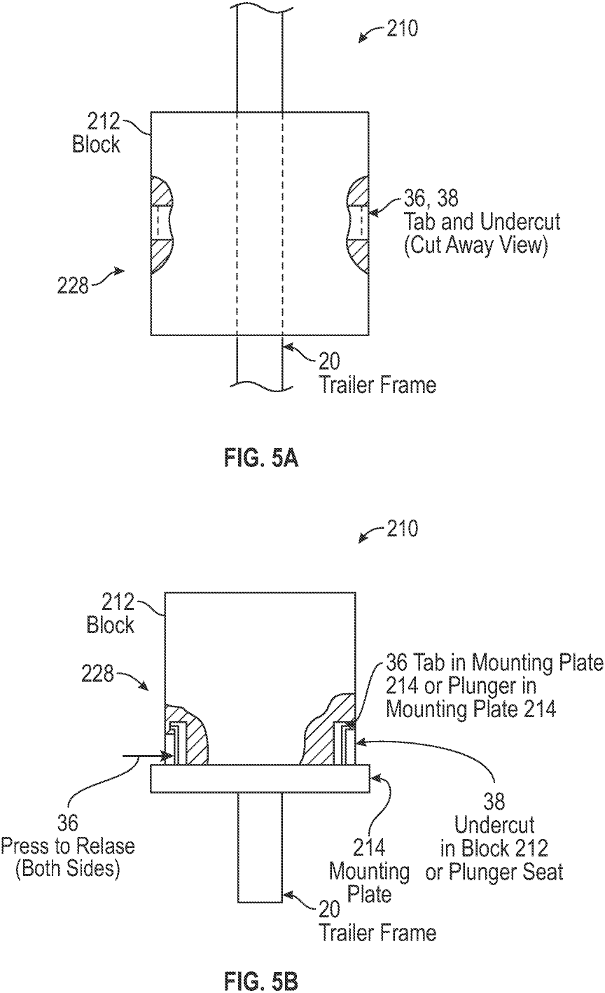

In FIGS. 5A and 5B, a coupling mechanism 228 between a support block 212 and an intermediate coupler member 214 of a support block assembly 210 constructed in accordance with another aspect of the disclosure uses spring loaded tabs 36 with a receptacle 38, such as an undercut or a plunger and plunger seat. The mounting plate 214 can be generally square in shape, as shown, or of any other geometry. To release the support block 212, the tabs 36 are pushed in while simultaneously removing the block 212. Alternatively, a plunger is used in the same manner; the plunger is either removed or the plunger spring force is overcome while the support block 212 is removed. The plunger and plunger seat can be a ball with detent or a retractable pin that extends into the plunger seat. Attachment methods can be used in a single or a plurality of locations within the support block assembly 210.

In the catch and pocket embodiment, a male catch feature 36 in the form of tabs or a plunger can be used to lock the support block 212 in place with a corresponding female feature 38 in the form of an undercut, pocket or detent. The support block 212 snaps into place when located within these features and the act of pushing or pulling the male catch feature 36 releases the support block 212 for removal.

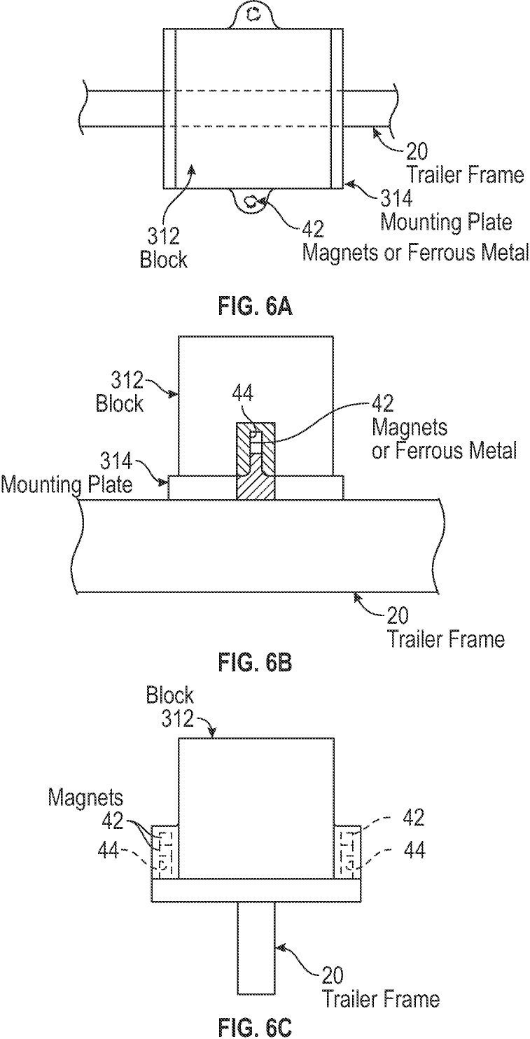

In FIGS. 6A-6C, a coupling mechanism between a support block 312 and an intermediate coupler member 314 of a support block assembly constructed in accordance with another aspect of the disclosure uses an alignment/capture feature, shown as including a magnetic feature 42 and a feature 44 for selective alignment and captured retention by the magnetic feature 42, such as a socket 44, embodiment wherein the support block 312 is secured to the mounting plate 314 with magnetic force coming from either the support block 312 or the mounting plate 314, or both. Either the support block 312 or the mounting plate 314 has the magnetic feature 42 shaped as a pin, post or other geometric shape that serves to align the support block 312 to the mounting plate 314. The magnetic feature 44 can be made of ferrous metal or magnetically charged to mate with the opposite component, be it the support block 312 or the mounting plate 314. The alignment/capture feature, described as a magnet 42 and socket 44, can be located around the perimeter of the support block assembly as shown, or located anywhere within the internal area of the support block 312 and mounting plate 314 components. The mounting plate 314 can be generally square in shape, as shown, or of any other geometry.

In the magnetic pin 42 and socket 44 embodiment, a male feature in the form of an alignment pin is located on a mounting plate 314. An opposing female feature in the form of a socket 44 in the support block 312 facilitates alignment between the two components 312, 314. The pin 42 can be made of ferrous metal, magnetized, can be an electromagnet, or can contain a permanent magnet to achieve a polarized magnet orientation. The socket 44 can contain a magnet oriented in an opposite polar orientation to achieve maximum magnetic force when in contact with the pin 42.

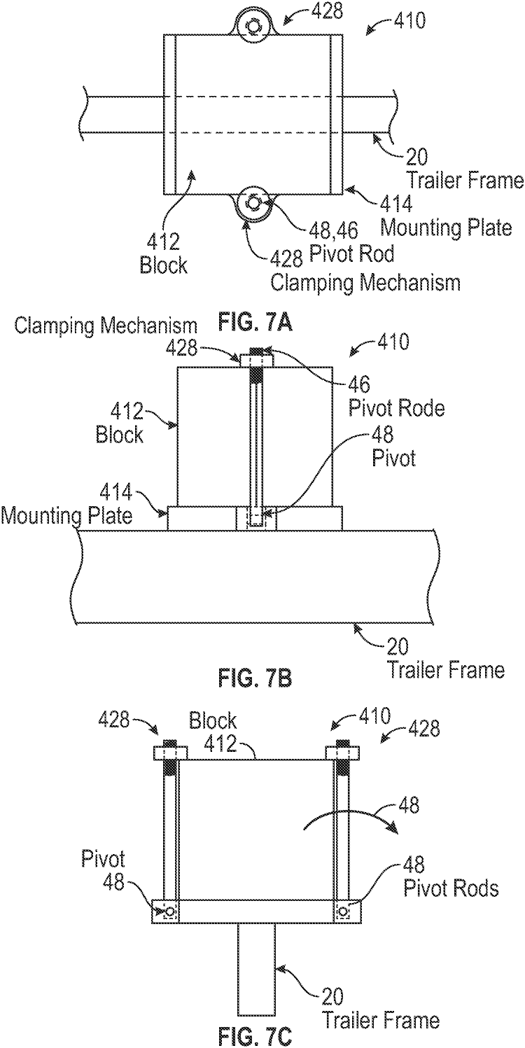

In FIGS. 7A-7C, a coupling mechanism 428 between a support block 412 and an intermediate coupler member 414 of a support block assembly 410 constructed in accordance with another aspect of the disclosure uses a vertical clamping mechanism 428 including a rod 46 which couples to the mounting plate 414 and clamps to the support block 412. The clamping mechanism 428 and rod 46 can be a screw, nut, bolt, lever, cam, hook and latch, suction cup, snap feature or friction device used in a single or a plurality of configurations. The rod 46 can couple to the mounting plate 414 by use of screw threads, press-fit, adhesive, welding, heat-staking, snap feature, tension fit, or can be molded into the mounting plate. The rod 46 can be detachable from the support block assembly 410 or can pivot away via a pivotal coupling 48 to facilitate removal of the support block 412; the rod 46 can stay rigidly in place or a combination of both can be used. The mounting plate 414 can be generally square in shape, as shown, or of any other geometry.

In the vertical clamp embodiment, the rod 46 can be made from a rigid material is coupled to the mounting plate 414 via the pivotal coupling 48 and moved, via being pivoted, into position to secure the support block 412 to the mounting plate 414. Coupled to the rod 46 is a clamping mechanism 428 that is adjusted to achieve vertical clamping force between the support block 412 and mounting plate 414.

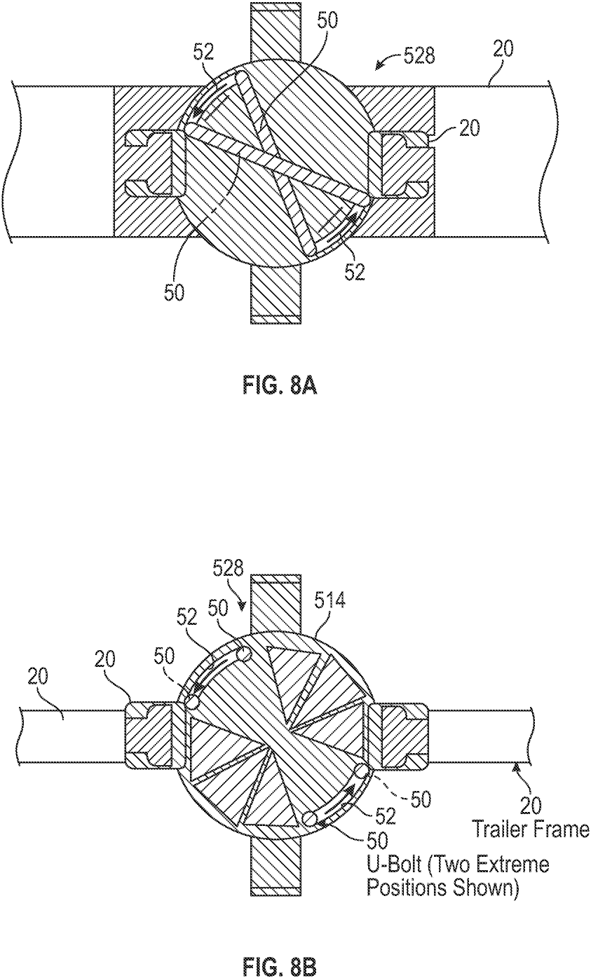

In FIGS. 8A and 8B, a coupling mechanism 528 between an intermediate coupler member 514 of a support block assembly constructed in accordance with another aspect of the disclosure and the trailer frame 20 is shown. The coupling mechanism 528 uses a U-bolt 50 or similar member which can be adjusted within the assembly to accommodate trailer frame construction of various sizes. A plate or strap on the underside of the U-bolt serves to couple it to the trailer frame. This plate or strap can be secured in place using bolts, screws, nuts, latches, cams, magnets, suction cups, adhesive material or other clamping mechanism. The U-bolt 50 can be used in a single or a plurality of configurations. The mounting plate 514, if used, can be generally circular in shape, as shown, or of any other geometry.

In the U-bolt clamp embodiment, a U-bolt 50 or comparable member is located in an adjustable slot feature 52 in the mounting plate 514 or the base of the support block. The U-bolt 50 extends past the depth of the trailer frame beam 20 and a strap or plate secures the assembly to the trailer frame 20. The U-bolt 50 rotates within the adjustment slot 52 allowing the support block assembly 510 to be configured to accommodate a variety of frame widths.

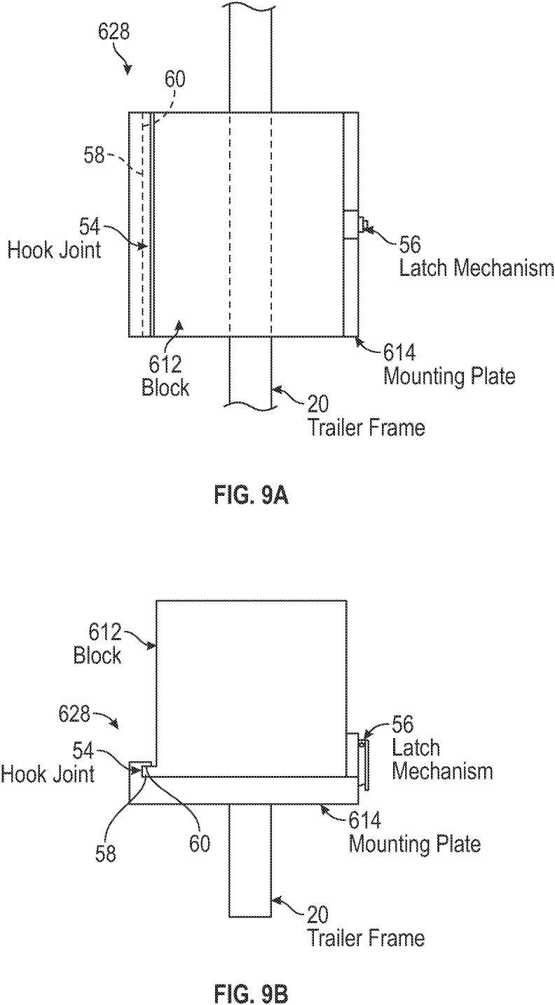

In FIGS. 9A and 9B, a coupling mechanism 628 between a support block 612 and an intermediate coupler member 614 of a support block assembly 610 constructed in accordance with another aspect of the disclosure uses a support block 612 coupled to a mounting plate 614 using a hook joint 54 and latch mechanism 56. The hook joint 54 includes a first feature 58 either coupled to or molded into the support block 612 that mates with an opposite second feature 60 either coupled to or molded into the mounting plate 614 to securely hold one side of the support block 612 in place. In an embodiment illustrated, the first feature 58 is an outwardly extending protrusion, also referred to as flange 58, and the second feature 60 is a recessed pocket or channel configured for close locking receipt of the flange 58 therein. The coupling mechanism 628 includes another feature located on the opposite side of the support block assembly 610, or along plurality of locations around the perimeter of the support block assembly 610, to hold and retain the other side of the support block 612 in place, shown in the nonlimiting embodiment as an over-center type clamp or latch 56. The hook joint 54 can extend the entire length of the support block assembly 610, as shown in FIGS. 9 and 9A. The mounting plate 614 can be generally square in shape as shown or of any other geometry.

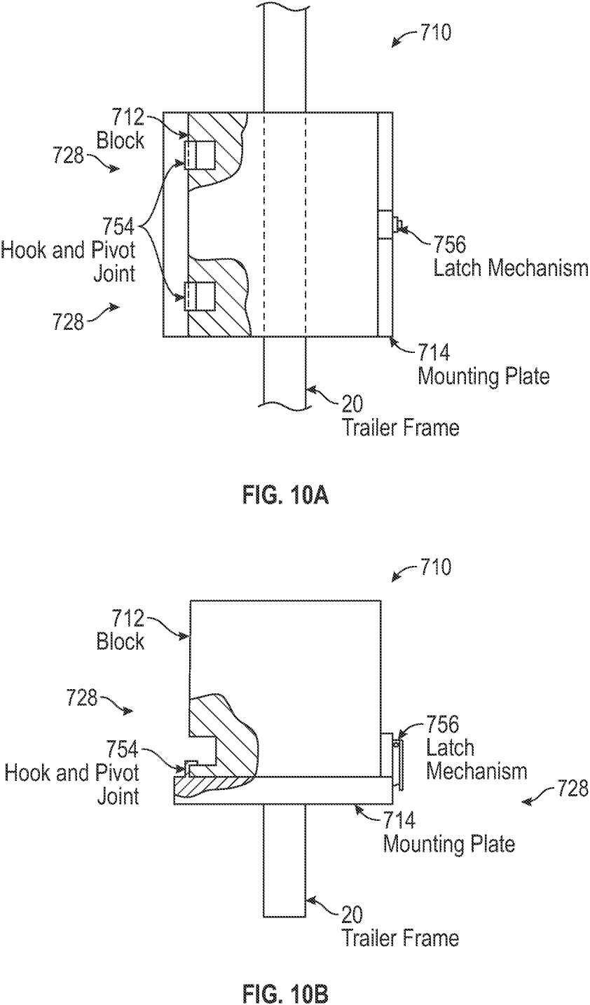

In FIGS. 10A and 10B, a coupling mechanism 728 between a support block 712 and an intermediate coupler member 714 of a support block assembly 710 constructed in accordance with another aspect of the disclosure uses a support block 712 coupled to a mounting plate 714 using a hook joint 754 and latch mechanism 756, similar to that discussed above for FIGS. 9 and 9A. However, rather than being a continuous hook joint, the hook joint 754 can be broken up into segments anywhere along the perimeter of the support block assembly 710. The mounting plate 714 can be generally square in shape as shown or of any other geometry.

Other embodiments can include one or more of the following items.
1. A support block assembly, comprising:
   an intermediate coupler configured to be directly attached to a trailer frame;
   a support block having a mounted position wherein the support block is directly and removably coupled to the intermediate coupler, and a dismounted position wherein the support block is released from the intermediate coupler, placed on an underlying ground surface and supports a jack post of the trailer frame.
2. The support block assembly wherein the support block is coupled to and removed from the intermediate coupler without need of tools.
3. The support block assembly wherein the intermediate coupler attaches to the trailer frame via a first connection mechanism, and the intermediate coupler attaches to the support block via a second connection mechanism.
4. The support block assembly wherein the first connection mechanism is adjustable to accommodate different configurations of trailer frames.
5. The support block assembly wherein the intermediate coupler is a mounting plate that is rectangular or round.
6. The support block assembly wherein the intermediate coupler is coupled to the trailer frame with a flexible strap that can be tightened in place with a coupling mechanism.
7. The support block assembly wherein the flexible strap extends through slots in the intermediate coupler, and the coupling mechanism is a clamp.
8. The support block assembly wherein the intermediate coupler is coupled to the trailer frame with a clamp mechanism and an adjustable stop.
9. The support block assembly wherein the clamp mechanism and adjustable stop are adjustable for movement along a slot in the intermediate coupler.
10. The support block assembly wherein the support block is coupled to the intermediate coupler with plungers and respective receptacles, such that the support block is released from the intermediate coupler by actuating the plungers.
11. The support block assembly wherein the plungers comprise male catch features and the receptacles comprise female features.
12. The support block assembly wherein the support block is coupled to the intermediate coupler with magnets.
13. The support block assembly wherein the support block is aligned on the intermediate coupler with a pin and socket.
14. The support block assembly wherein the support block is coupled to the intermediate coupler with a vertical clamping mechanism.
15. The support block assembly wherein the vertical clamping mechanism comprises a rod that is pivotally coupled to the intermediate coupler, and the rod adjustably engages and retains the support block on the intermediate coupler.
16. The support block assembly wherein the support block is coupled to the intermediate coupler with a U-bolt that is rotatably adjustable in a slot of the intermediate coupler.
17. The support block assembly wherein the support block is coupled to the intermediate coupler with a hook joint and a latch mechanism.
18. The support block assembly wherein the hook joint comprises complementary mating features on the support block and intermediate coupler.
19. The support block assembly wherein the hook joint extends an entire length of both the support block and the intermediate coupler.
20. The support block assembly wherein the hook joint is segmented along perimeters of the support block and the intermediate coupler.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A support block assembly, comprising:
an intermediate coupler configured to be directly attached to a trailer frame;
a support block having a mounted position wherein the support block is directly and removably coupled to the intermediate coupler, and a dismounted position wherein the support block is released from the intermediate coupler, placed on an underlying ground surface and supports a jack post of the trailer frame.

2. The support block assembly of claim 1, wherein the support block is coupled to and removed from the intermediate coupler without need of tools.

3. The support block assembly of claim 1, wherein the intermediate coupler attaches to the trailer frame via a first connection mechanism, and the intermediate coupler attaches to the support block via a second connection mechanism.

4. The support block assembly of claim 3, wherein the first connection mechanism is adjustable to accommodate different configurations of trailer frames.

5. The support block assembly of claim 1, wherein the intermediate coupler is a mounting plate that is rectangular or round.

6. The support block assembly of claim 1, wherein the intermediate coupler is coupled to the trailer frame with a flexible strap that can be tightened in place with a coupling mechanism.

7. The support block assembly of claim 6, wherein the flexible strap extends through slots in the intermediate coupler, and the coupling mechanism is a clamp.

8. The support block assembly of claim 1, wherein the intermediate coupler is coupled to the trailer frame with a clamp mechanism and an adjustable stop.

9. The support block assembly of claim 8, wherein the clamp mechanism and adjustable stop are adjustable for movement along a slot in the intermediate coupler.

10. The support block assembly of claim 1, wherein the support block is coupled to the intermediate coupler with plungers and respective receptacles, such that the support block is released from the intermediate coupler by actuating the plungers.

11. The support block assembly of claim 10, wherein the plungers comprise male catch features and the receptacles comprise female features.

12. The support block assembly of claim 1, wherein the support block is coupled to the intermediate coupler with magnets.

13. The support block assembly of claim 12, wherein the support block is aligned on the intermediate coupler with a pin and socket.

14. The support block assembly of claim 1, wherein the support block is coupled to the intermediate coupler with a vertical clamping mechanism.

15. The support block assembly of claim 14, wherein the vertical clamping mechanism comprises a rod that is pivotally coupled to the intermediate coupler, and the rod adjustably engages and retains the support block on the intermediate coupler.

16. The support block assembly of claim 1, wherein the support block is coupled to the intermediate coupler with a U-bolt that is rotatably adjustable in a slot of the intermediate coupler.

17. The support block assembly of claim 1, wherein the support block is coupled to the intermediate coupler with a hook joint and a latch mechanism.

18. The support block assembly of claim 17, wherein the hookjoint comprises complementary mating features on the support block and intermediate coupler.

19. The support block assembly of claim 18, wherein the hookjoint extends an entire length of both the support block and the intermediate coupler.

20. The support block assembly of claim 18, wherein the hookjoint is segmented along perimeters of the support block and the intermediate coupler.
